(19) United States
(12) Patent Application Publication
(10) Pub. No.: US 2021/0110056 A1
(43) Pub. Date: Apr. 15, 2021

(54) MULTI-REGIONAL DATA STORAGE AND QUERYING

(71) Applicant: ACCELERATOR MARKETING, LLC, DBA BITBUILD, Lehi, UT (US)

(72) Inventors: Peter Ehat, Lehi, UT (US); Nathan Anderson, Saratoga Springs, UT (US); Sterling Hurd, Orem, UT (US)

(73) Assignee: ACCELERATOR MARKETING, LLC, DBA BITBUILD, Lehi, UT (US)

(21) Appl. No.: 17/067,293

(22) Filed: Oct. 9, 2020

Related U.S. Application Data
(60) Provisional application No. 62/914,728, filed on Oct. 14, 2019.

(51) Int. Cl. G06F 21/62; G06F 21/60; H04L 9/08; H04L 9/06; G06F 16/901; G06F 16/9038; G06F 16/903; G06F 16/2455; G06F 16/28

(52) U.S. Cl. CPC G06F 21/6227; G06F 21/602; H04L 9/0872; H04L 9/0643; G06F 16/288; G06F 16/9038; G06F 16/90335; G06F 16/24554; G06F 16/9024

(57) ABSTRACT

A method for writing with a DIRE (data integration and routing engine) controller may comprise receiving, by an application protocol interface (API) server, data from an end-user, and splitting, by the API server, the data in multiple ways based on directives contained in a data privacy and handling policy of a user, wherein the splitting includes using a hashing algorithm to create a key representing a document of the data. The data may be processed through the DIRE controller. For example, the DIRE controller may tag the key with geolocation information for future retrieval; the DIRE controller may route the data to a server in a geolocation based on the geolocation information; and the DIRE controller may maintain a key-value pair database that maps the key to the geolocation of the document for later retrieval. The disclosure also includes a system or method for reading with a DIRE controller.

### CROSS-REFERENCE TO RELATED APPLICATIONS

This application claims priority to, and the benefit of, U.S. Ser. No. 62/914,728 filed Oct. 14, 2019 and entitled “Multi-Regional Data Storage and Querying,” which is hereby incorporated by reference in its entirety for all purposes.

### FIELD

This disclosure generally relates to data storage, and more particularly, to a Web-based software system to read and write datasets, while seamlessly storing specific shards of data in different geographical locations.

### BACKGROUND

A technical problem exists in that storing individual data points in different geographic locations can often be challenging. Because of certain data localization and data sovereignty laws, it is becoming more common for people to request data storage solutions that allow for storage of data for certain users to be stored in a specific country or specific location. Data that would typically be saved within a database (e.g. responses to a questionnaire) could usually be saved within a single table on a database residing on a server in a specific geographic location. In that regard, when storing a user's responses to a questionnaire in a specific geographic location, the separation and querying of the data would all take place at the application layer. When storing individual points of data (a single cell instead of an entire row of data) in a specific geographic location, querying data back to the application would become very difficult and time-consuming. Moreover, accessing the data for the application from a single location would not be possible.

Current data sharding techniques often allow developers to create applications that split data among separate machines (or nodes), wherein the data is split in various ways to accommodate scaling and load. Two common techniques for sharding relational (not graph) database systems include splitting data vertically by storing different tables in separate databases, or horizontally by storing a table's rows across multiple database nodes. Data sharding is common and is used to provide for efficient data scaling and improved performance. However, these traditional sharding techniques do not often work effectively for splitting data according to geographic significance because the destination of data is determined by database load, rather than by the type of data being stored. As such, a need exists for an improved system to read and write datasets, while seamlessly storing specific shards of data in different geographical locations.

### SUMMARY

In various embodiments, a method for writing with a DIRE (data integration and routing engine) controller may comprise receiving, by an application protocol interface (API) server, data from an end-user (step 205), and splitting, by the API server, the data in multiple ways based on directives contained in a data privacy and handling policy of a user, wherein the splitting includes using a hashing algorithm to create a key representing a document of the data (step 210).

The data may be processed through the DIRE controller. For example, the DIRE controller may tag the key with geolocation information for future retrieval (step 215); the DIRE controller may route the data to a server in a geolocation based on the geolocation information (step 220); and the DIRE controller may maintain a key-value pair database that maps the key to the geolocation of the document for later retrieval (step 225).

The key may include any arbitrary type of information and amount of information. The key may represent a pointer to the document within a local graph database. The DIRE controller determines where the data is stored based upon settings included in the data privacy and handling policy of the user. The DIRE controller may determine where the data is stored based upon geolocation-specific needs. The data privacy and handling policy may be hard-coded.

In various embodiments, a method for reading with a DIRE may comprise receiving, by an API server, queries based on data relationships from a user (step 305); splitting, by the API server, the queries (step 310); submitting, by the API server, the queries directly to a local graph database (step 315), wherein using graph relationships and pathfinding algorithms, the local graph database answers the query (step 320), wherein the local graph database returns identifier keys back to a server (step 325), wherein the identifier keys each represent data stored elsewhere on a geo-specific server at a different physical location, wherein the server submits the identifier keys to a DIRE controller for mapping with documents (step 330), wherein the DIRE controller consults a local key-value pair database of the DIRE controller that contains a matching of the identifier keys and a value designation corresponding to a physical location of the data of each document of the documents (step 335), wherein the DIRE controller collects the documents from the geographical locations (step 340); and receiving, by the API server, each of the documents as JSON (step 345).

Each of the queries from the API server may include an ID of the document as well as a type of the document, wherein the ID is used to query the key-value pair database, and wherein one of the identifier keys is the ID and the value designation indicates the database in which the document is stored. Moreover, the queries may be raw data queries.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is an exemplary system diagram, in accordance with various embodiments.

FIG. 2 is an exemplary process flow diagram for writing with a DIRE controller, in accordance with various embodiments.

FIG. 3 is an exemplary process flow diagram for reading with a DIRE controller, in accordance with various embodiments.

### DETAILED DESCRIPTION

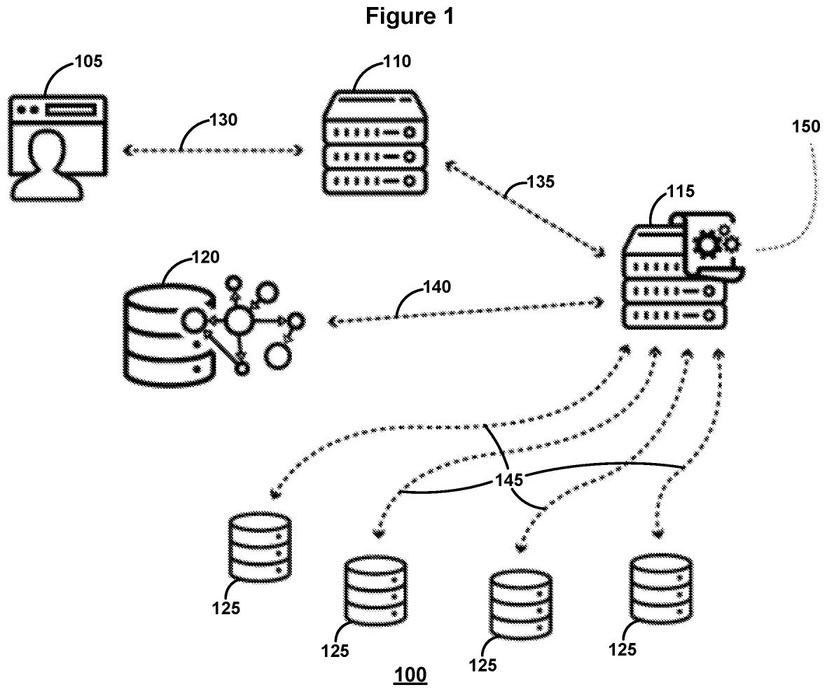

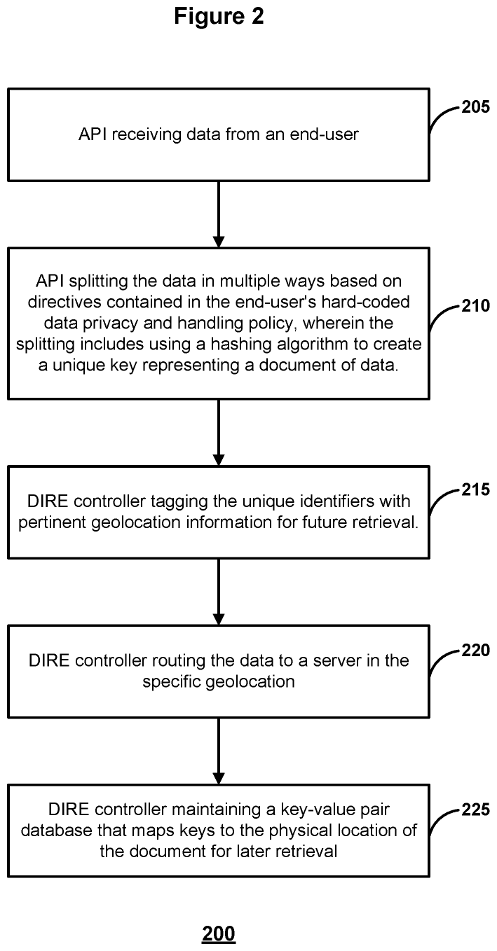

With respect to writing with a DIRE (data integration and routing engine) controller, in various embodiments and with respect to FIGS. 1 and 2, the API server 110 receives data 135 from the end-user device 105 via an API request/response 130. In various embodiments, readable data is not written to any storage hardware, except in the location determined by the API client's specifications. The API server 110 may split the data 135 in one or more ways. The splitting may follow directives contained in the end-user's data privacy and handling policy 150. The data privacy and handling policy 150 may be hard-coded. For example, the API server 110 creates a unique, but ultimately meaningless “key” that represents a “document” of data 135 and forms the hashed data 140. The document can include any arbitrary type and/or amount of information (e.g., user name, test name, etc.). This key now represents what amounts to a pointer to that document. The API server 110 sends the key to a local graph database 120 (i.e. Neo4j). The data 135 itself is processed through a DIRE controller 115. The DIRE controller 115 determines (e.g., based upon a number of settings included in the user's data privacy and handling policy 150) where the readable data 145 should be physically stored. Settings provide a series of key value pairs that are used by the DIRE engine to write data to different locations based on each setting. For example, a setting for a single quiz might have a value showing that its data should be stored on a server located in Canada. The setting contains information about the quiz, and information about where to store the data (e.g. an ID for a specific server). The determination may be based on geolocation-specific needs stored in the user's data privacy and handling policy 150 (e.g., the end-user's desire to adhere to various government data laws and regulations). Settings are specific to each API user, and can be customized to work with their own policies.

The DIRE controller 115 processes the data 135. In various embodiments, the DIRE controller 115 may route the data 135 to a server in the specific geolocation. The DIRE controller 115 may tag the unique identifiers (the key can be the identifier) with pertinent geolocation information (e.g. an ID for a server in a specific location) for future retrieval. The server stores the data 135 in a document-based data store 125 (i.e. MongoDB). The DIRE controller 115 maintains a key-value pair database that maps keys to the physical and logical location of the document for later retrieval. No (or minimal) geolocation-specific sensitive data is stored outside of the servers designated for that geolocation. The data 135 is categorized as sensitive based on the end-user's data privacy and handling policy 150. Settings for sensitivity are stored in the key value pairs of the unique setup for each client. However, the graph database 120 maintains relationships between the keys that allows for querying the hashed data 145 without knowing specific details about each document.

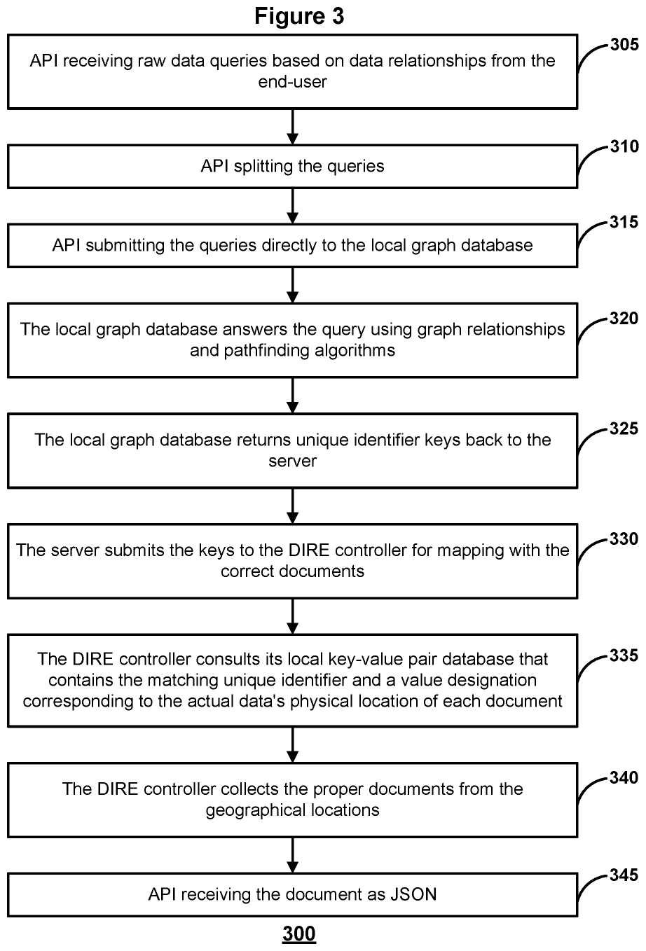

With regard to reading with a DIRE, in various embodiments and with respect to FIGS. 1 and 3, the API server 110 receives raw data queries 130 (e.g., based on data relationships from the end-user). The API server 110 runs those queries in parallel on the target servers where the data is located. In various embodiments, in a first route, the API server 110 may submit the query directly to the local graph database 120. Using graph relationships and pathfinding algorithms, the local graph database 120 answers the query by merging the responses from those parallel queries and returns them to the graph database as a single response. The local graph database 120 returns identifier keys back to the API server 110. The identifier keys may each represent readable data 145 stored elsewhere in a database 125 on a geo-specific server at a different physical location. The API server 110 submits all or a portion of these keys to the DIRE controller 115 for mapping with the correct documents. In particular, with the given identifier keys, the DIRE controller 115 consults its local key-value pair database that contains the matching unique identifier and/or a value designation corresponding to the readable data's 145 physical location of each document. The DIRE controller 115 collects the proper documents including readable data 145 from their geolocation specific databases 125 at their respective geographical locations. In various embodiments, each query 130 from the API server 110 may include the requested document's unique ID as well as the document's type (student, class, response, etc). Such unique ID is used to query the key-value pair database. The key may represent or be the unique ID and the value may be associated with or indicate the geolocation specific database 125 in which the document is stored. The targeted geolocation specific database 125 can be queried for the requested document based on the ID and type. Each document is associated with an ID and type, so the targeted geolocation specific database 125 searches for the requested document based on the ID and type. The geolocation specific database 125 returns the requested document as JSON to the API server 110. In the case where multiple documents are requested, each of their IDs are included in the query from the API server 110. In various embodiments, when multiple documents are requested, each of the multiple documents in the request will be of the same type because of the nature of the query. The IDs are passed to the key-value database to get the geolocation specific databases 125 in which the documents are located. To expedite the process, the IDs are grouped by geolocation specific database 125. Each of the geolocation specific databases 125 may be queried asynchronously for the documents they contain. Once all geolocation specific databases 125 have responded, the documents are mapped to a JSON object where the keys are the IDs and values are the documents associated with the IDs.

In various embodiments, the data 135 may be split into two parts, relationships and values. Relationships are how one document is related to another. For example, a Student document can have a relationship of is_enrolled_in with a Class document. A Class document can have a relationship of is_taught_by with a Professor document. Values are the actual data 135 contained in a document. For example, a Student might contain values such as Name, Address, or Phone Number. A Class might have values such as Name or Credit Hours. The relationships may be stored in the graph database 120 in the API server 110. The values may be stored on servers in various geographic locations as required by law.

An example query 130 might be “Get me all the professors with the first name of John that teach classes in the History Department”. The first step would be to query the graph database 120 for “Professor” nodes with the “teaches” relationship with “Class” nodes with the “belongs to” relationship with the “Department” node with the ID of the history department. This returns a list of “Professor” nodes and their associated IDs. The DIRE controller 115 is queried for those IDs. The DIRE controller 115 returns the documents containing the values for each of the requested professors from the geolocation specific databases 125. With the values for the professors, the system can filter the professors to only those who First Name value is equal to John.

In various embodiments, a second route may be used for queries 130 which contain geolocation-specific data 135. The query 130 may be submitted to the DIRE controller 115. The DIRE controller 115 may query the geolocation specific databases 125 individually and in their specific locations. The DIRE controller 115 may run as an internal DNS service which resolves all requests to the geolocation specific databases 125 which return results to the API server 110. For example, a professor queries 130 the user ID of a student that answered “C” on a test. Because this request involves specific values, the system submits the query 130 to the DIRE controller 115 for answering based on a query 130 of the geolocation specific databases 125 individually. The DIRE controller 115 returns the answers to the API server 110. In various embodiments, queries 130 can be cached on the backend (e.g., in-memory only) for faster results in the future.

The system and process flows depicted are merely embodiments and are not intended to limit the scope of the disclosure. For example, the steps recited below in any of the method or process descriptions may be executed in any order and are not limited to the order presented. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Terms and phrases similar to “associate” and/or “associating” may include tagging, flagging, correlating, using a look-up table or any other method or system for indicating or creating a relationship between elements.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

In various embodiments, the server may include application servers (e.g., WEBSPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA′ Virtual Machine running on LINUX® or WINDOWS® operating systems).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE CHROME™ software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, DISH NETWORK®, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol known in the art. Transactions originating at a web client may pass through a firewall in order to prevent unauthorized access from users of other networks. Further, additional firewalls may be deployed between the varying components of CMS to further enhance security.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MDS, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rAPI server 110dly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any communication, transmission, and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word or EXCEL™, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

1. A method for writing with a DIRE (data integration and routing engine) controller, comprising:
receiving, by an application protocol interface (API) server, data from an end-user; and
splitting, by the API server, the data in multiple ways based on directives contained in a data privacy and handling policy of a user,
wherein the splitting includes using a hashing algorithm to create a key representing a document of the data, and
wherein the data is processed through the DIRE controller by:
tagging the key with geolocation information for future retrieval;
routing the data to a server in a geolocation based on the geolocation information; and
maintaining a key-value pair database that maps the key to the geolocation of the document for later retrieval.

2. The method of claim 1, wherein the key includes any arbitrary type of information and amount of information.

3. The method of claim 1, wherein the key represents a pointer to the document within a local graph database.

4. The method of claim 1, wherein the DIRE controller determines where the data is stored based upon settings included in the data privacy and handling policy of the user.

5. The method of claim 1, wherein the DIRE controller determines where the data is stored based upon geolocation-specific needs.

6. The method of claim 1, wherein the data privacy and handling policy is hard-coded.

7. A method for reading with a DIRE comprising:
receiving, by an API server, queries based on data relationships from a user;
splitting, by the API server, the queries;
submitting, by the API server, the queries directly to a local graph database,
wherein using graph relationships and pathfinding algorithms, the local graph database answers the query,
wherein the local graph database returns identifier keys back to a server,
wherein the identifier keys each represent data stored elsewhere on a geo-specific server at a different physical location,
wherein the server submits the identifier keys to a DIRE controller for mapping with documents,
wherein the DIRE controller consults a local key-value pair database of the DIRE controller that contains a matching of the identifier keys and a value designation corresponding to a physical location of the data of each document of the documents,
wherein the DIRE controller collects the documents from the geographical locations; and
receiving, by the API server, each of the documents as JSON.

8. The method of claim 7, wherein each of the queries from the API server includes an ID of the document as well as a type of the document, wherein the ID is used to query the key-value pair database, and wherein one of the identifier keys is the ID and the value designation indicates the database in which the document is stored.

9. The method of claim 1, wherein the queries are raw data queries.

10. A system comprising:
a DIRE controller having a processor and a tangible, non-transitory memory configured to communicate with the processor;
a local graph database;
a first server;
a second server; and
an application protocol interface (API) server;
the API server configured to receive queries based on data relationships of data from a user;
the API server configured to split the queries;
the API server configured to submit the queries directly to a local graph database;
the local graph database configured to answer the query by using graph relationships and pathfinding algorithms;
the local graph database configured to return identifier keys back to a first server;
the second server configured to store the data at a different physical location, wherein the keys each represent the data stored on the second server;
the server configured to submit the keys to the DIRE controller for mapping with documents;
the DIRE controller configured to consult a local key-value pair database of the DIRE controller that contains a matching of the identifier keys and a value designation corresponding to a physical location of the data of each document of the documents;
the DIRE controller configured to collect the documents from the geographical locations; and
the API server configured to receive the documents as JSON.

11. The system of claim 10, wherein each query from the API server includes the requested document's unique ID as well as the document's type, wherein the ID is used to query the key-value pair database, and wherein the key is the ID and the value indicates the database in which the document is stored.

12. The system of claim 10, wherein the second server is a geo-specific server.
